(19) United States
(12) Patent Application Publication
(10) Pub. No.: US 2009/0134038 A1
(43) Pub. Date: May 28, 2009

(54) Method of Chemical Reactions Conduction and Chemical Reactor

(76) Inventors: Tadeusz Chudoba, Warszawa (PL); Edward Reszke, Wroclaw (PL); Witold Lojkowski, Warszawa (PL); Janusz Fidelus, Mucharz (PL)

Correspondence Address: Horst M Kasper, 13 Forest Drive, Warren, NJ, 07059, US

(21) Appl. No.: 12/083,330

(22) PCT Filed: Oct. 5, 2006
(86) PCT No.: PCT/PL2006/000066

§ 371 Date: Apr. 7, 2008

(30) Foreign Application Priority Data
Oct. 5, 2005 (PL) P.377451

(51) Int. Cl. B01J 19/08; C25B 1/00

(52) U.S. Cl. 205/341; 422/186.04

(57) ABSTRACT

In the method at least two electrodes (1, 2) and fluid reagents (4) are placed in the reaction vessel (3). At least one fluid substrate (11) of the fluid reagents (4) is capable of electric polarization. The reagents (4) are subjected to electric voltage in the form of a series of short electric pulses in such way that unipolar or bipolar electric field pulses are generated. The minimum duration time of electric pulses is from 50 ns and the maximum is 20 ms. The pause between the consecutive pulses is from 0.5 μs to 3 s. In the reactor at least two electrodes (1, 2) are connected to the electric power adaptor delivering unipolar or bipolar pulses of direct or alternating voltage which constitutes the source of the electric field with amplitude exceeding 100V/cm. The electrodes (1, 2) are placed in the reaction vessel (3) filled with fluid reagents (4) which contains at least one liquid substrate (11) capable of electric polarization.

### TECHNICAL FIELD

The invention relates to method of conduction of chemical reactions between elements of a substrate mixture in which at least one is a fluid or which constitute the mixture of liquids where at least one element is capable of electric polarization as well to a chemical electrode-type reactor designed to conduct such reactions.

### BACKGROUND ART

Chemical reactors in the form of galvanic devices equipped with two electrodes immersed in the liquid which is contained in galvanic cell tank are well known and often used. These devices serve to perform galvanic coating with one electrode made of the coating material and the other made of the object to be coated. Normally, the coated object makes the cathode and the direct current is needed in the process. Average intensity of the current between the electrodes is also an important factor. The composition of electrolyte should be picked in such a way that the working voltage of the galvanizing tank is as small as possible.

Other known chemical reactors which take advantage of electrochemical techniques are used in the process of extraction of heavy metals from solutions. Their common feature is the use of a galvanic cell fitted with the cathode which is connected to the negative terminal of the power supply and the anode connected to the positive terminal. The reaction products are collected at one of the electrodes.

In U.S. Pat. No. 6,328,875 have been disclosed an electrolyte device as well as method of water solutions purification and chemical agents synthesis. This device is claimed to electrically purify contaminated water, especially ground water and industrial wastewaters from such production plants as paper mills, food and textile processing plants. This method consists in purification, decolouration and sterilization by means of an improved, more economical electrolyte cell with an open configuration having electrodes with a number of conductive porous elements in electrical contact with each other. These cells can be divided or not divided and connected within a unipolar or bipolar configuration. A more economical operation is achieved especially with the use of narrow capillary apertures between the electrodes, especially when purifying solutions of low conductance. The device is particularly useful in the processes of electro-synthesis of chemical agents, both organic and inorganic such as perchlorate bleaching agents and other types of oxidants.

### DISCLOSURE OF INVENTION

In method according to the invention electrodes connected to a power supply are immersed in fluid reagents. At least one component of the reagent is capable of electric polarization. Said fluids reagents are subjected to electric voltage in the form of short electric pulses generating unipolar or bipolar electric field pulses.

In one variety of the method the minimum duration time of the electric pulses is from 50 ns and the maximum is 20 ms, while pause between the consecutive pulses is from 0.5 μs to 3 s. Advantageously in the method the fluid reagents are subjected to the electric voltage generating electric field strength with intensity of at least 100V/cm. Also advantageously the fluid reagents are subjected to the pulses of electric voltage causing the delivery of the in-pulse electric power to be at least 10 times higher than the average power level. During conducting the method the fluid reagents can be cooled down Advantageously, in the method the rate of tension increase in the pulse exceeds 108 V/sec. Duration of the electric pulses used in the method, defined as time where 90% of the pulse energy is included, can be in the range from 1 μs to 20 ms. Advantageously power consumption in reaction conducted according to the method is more than 1 kW/ml, as well as the fluid reagents are under pressure up to 50 MPa.

Chemical reactor according to the present invention has a reaction vessel for fluid reagents subjected to the reaction which is equipped with at least two electrodes to be immersed in the fluid reagents. Said electrodes are made of electrically conducting material and connected to electric power supply. The electric power supply is a source of unipolar or bipolar pulses of pulsing DC or AC voltages which constitutes source of the electric field strength with amplitude exceeding 100V/cm. The electrodes are in galvanic contact with the fluid reagents or are separated from by a relatively thin layer of dielectric material.

Advantageously the reaction vessel has rectangular shape formed by two first parallel walls made of electrically conductive material and playing role of a pair of plate-type electrodes, as well as by second two parallel walls and bottom made of dielectrically isolating material. In the reactor at least one electrode can play role of one internal wall of the reaction vessel. The electrodes can be also connected by the bushings situated at the walls of the reaction vessel as well as the reaction vessel filled with the fluid reagents can be advantageously situated in the high pressure tank or in the low pressure tank and moreover the vessel can be also fitted with the cooling system. Advantageously the electrodes immersed in the fluid reagents are connected to a cooling system. The electrodes can be made of a material not contaminating the reaction product or made of a material identical with the components of the reaction product. Advantageously a cladding made of low electric conduction material or of electric insulator are applied on the electrodes and the cladding can be of porous texture. Advantageously at least one electrode of the reactor has form of a rectangular sheet metal, form of a tube, form of a rod or form of a flat plate. At last a one of the electrodes can have openings. Advantageously, the rate of tension increase in the electric pulse exceeds 108 V/sec and time of pulse duration, defined as time where 90% of the pulse energy is included, is in the range from 1 μs to 20 ms as well as power consumption during the reaction is more than 1 kW/ml of the fluid reagents. Fluid reagents in the reagents can be under pressure up to 50 MPa.

The advantage of the method according to the present invention is the resulting selective energy supply necessary to conduct chemical reaction in the reactor's whole volume. It is attained by equipping the reactor with two or more electrodes placed in any reaction vessel or alternatively in the reactor's flow tube in order to ensure the flow of current through a circuit connected to a pulsed-type power supply made of impulse power supply and the electrodes. The circuit with pulsed currents becomes closed with the help of a liquid found in the vessel containing the reagents indispensable to conduct the intended chemical reaction. In this method the amount of energy supplied to the reagents is easy to control because it is not stored in the heating system and, therefore, disconnecting the power supply immediately stops the energy from flowing to the reagents. Moreover, the instantaneous values of the current and electrode average and impulse voltage are the source of information about the status of the reaction since the subsequent stages of the reaction are accompanied by appropriate changes of complex permittivity easy to monitor at the side of the circuits of electric supply.

The chemical reactor according to the invention is a pulsed mode chemical reactor which has not been written about nor used in the industry processes. The reagents are electrically stimulated by the electrodes which deliver short impulses of electric voltage. Stimulating the voltage by impulses enables volumetric effect of induction similar to microwave reactors. However, the average value of energy necessary to conduct the chemical reaction in the new reactor is very low. This reactor is especially useful in the production of different kinds of nanopowders applied in nanotechnology. The scope of application of the new reactor depends on the reagents subject to the reaction and obtained products. It should be noted that the choice of the parameters of the impulse process such as the duration time of a single pulse, duration time of a pause between the pulses, the pulse amplitude, the way and time of their recurrence and especially the amount of energy supplied cyclically, in pulse trains and bursts packs or in single pulses is made according to the reagents properties as well as other parameters of reactor's work such as required temperature, pressure and process efficiency.

### BRIEF DESCRIPTION OF DRAWINGS

The several embodiments of reactor according to the invention are presented on the attached drawings, where:

FIG. 1 shows a two-electrode cylindrical reactor in cross-section;

FIG. 2 shows a flat reactor with electrodes connected with the cooling system in cross-section;

FIG. 3 shows a cylindrical reaction vessel closed with electrodes in cross-section;

FIG. 4 shows a cylindrical reactor featuring continuous operation in cross-section;

FIG. 5 shows a perpendicular reaction vessel with electrodes forming its walls in cross-section.

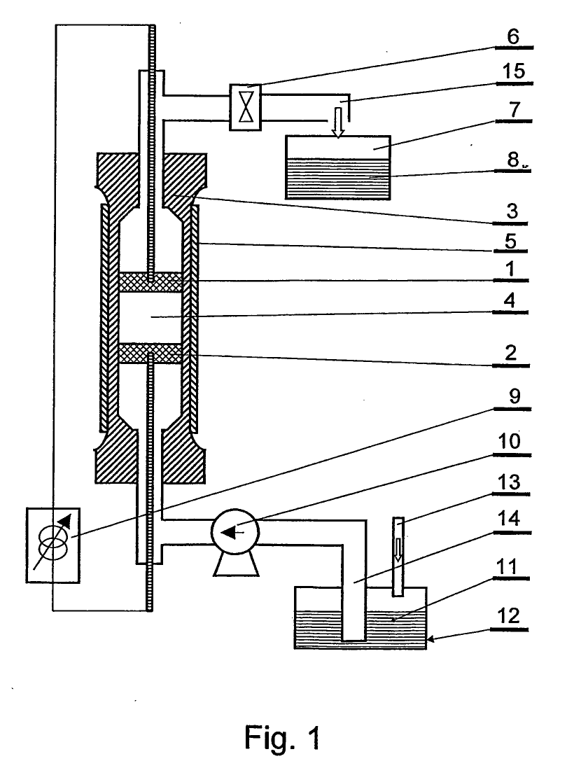

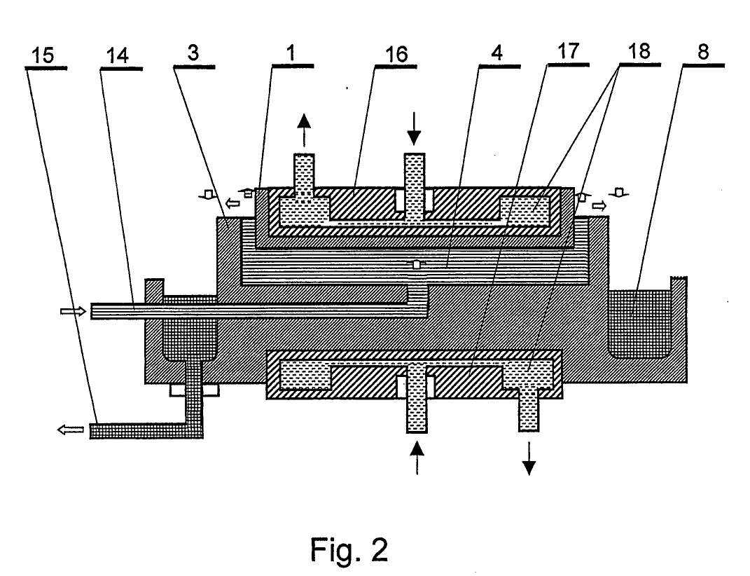

### MODE FOR CARRYING OUT THE INVENTION

### Example 1

Two electrodes 1, 2 and fluid reagents 4 (of which at least one liquid substrate 11 is capable of electric polarization) has been placed in the reaction vessel 3. After that the reagents 4 have been exposed to electric voltage generating electric field strength with amplitude of 1 kV/cm in the form of short rectangular bipolar and symmetric impulses of electricity with duration time of 50 ns and pauses between consecutive impulses of 0.5 μs. Furthermore, the relation of impulse power to the average power delivered to the reagents was 10.

### Example 2

The conduction of the reaction was similar to the first example. The only difference was that the rectangular unipolar impulses were supplied to the electrodes. The duration time of electric impulses was 0.2 ms and the pause was 2 s. The reagents 4 become exposed to the voltage generating electric field strength with the intensity of at least 16 kV/cm. The relation of impulse power to the average power delivered to the reagents 4 was 10000.

### Example 3

The conduction of the reaction was similar to the first or second example. However, the pause time between the pulses has been modified in such a way that the relation of the impulse power to the average power delivered to the reagents was 100 and, additionally, the reagents 4 are cooled down.

### Example 4

The chemical electrode-type reactor, which constitutes cylindrical two-electrode reactor, has two electrodes 1 and 2 connected by bushings situated at the walls of the reaction vessel 3, with electric power adaptor 9 delivering unipolar or bipolar impulses of direct or alternating voltage which constitutes the source of the electric field strength in excess of 100V/cm. Electrodes 1 and 2 were placed in the cylindrical reaction vessel 3 filled with reagents 4 which contains one liquid substrate 11 capable of electric polarization. Substrates 11 from the substrate tank 12 were passed through the input 14 of the reactor and the pump 10 to the reaction vessel 3. The work of the pump 10 was supported by compressed gas fed from the compressor through the connection terminal 13. However, the reaction products 8 were directed to the product tank 7 by means of a valve 6 situated at the output 15 of the reactor. The electrodes 1 and 2 were gauze electrodes and, finally, an insulating coating acting as a pressure cover was put on the reaction vessel 3.

### Example 5

The electrode chemical reactor was similar to the one in the example four but this time it was a flat reactor featuring circular electrodes covered with cladding. The upper impulse electrode 1 is connected to the cooling system and is situated at the upper section of the reaction vessel 3, formed at the upper section of the lower circular electrode 2. The lower electrode 2 was moulded in such a way that the reaction vessel 3, being a cylindrical cavity in the circular electrode 2, was at its centre and a groove in the shape of a chute was made around this electrode constituting the substrate tank 12. Furthermore, there was a cooling system 17 placed centrally under the reaction vessel 3. The water 18 has been used as a cooler in both cooling systems (16 and 17) of the electrodes. This reactor's lower electrode 2 was grounded.

### Example 6

The electrode chemical reactor was similar to the one in the example four but this time it had a dielectric ring closed from the top and bottom by the circular electrodes 1 and 2 mounted on the dielectric base 20. There was an opening in the upper electrode 1 serving as a filler viewfinder 19. The electrodes constitute the walls of the reaction vessel 3 and are made of the material chemically identical with the components of the reaction products.

### Example 7

The electrode chemical reactor was similar to the one in the example four but this time it had two flat electrodes 1 and 2 whose surfaces constitute the capacitor screens. These electrodes were connected by rectangular dielectric plates 21 and formed a perpendicular reaction vessel. Additionally, the electrodes 1 and 2 were produced from the material not contaminating the reaction product.

### Example 8

This electrode chemical reactor made as a cylindrical impulse reactor featuring continuous operation had seven electrodes of which three are impulse ones 1 and the remaining four ones 2 are grounded. The electrodes 1 and 2 were mounted at the walls of the reaction vessel 3 covered with an insulating coating 5 on the outside. Moreover, the electrodes 1 and 2 covered with a cladding of electric insulator feature openings enabling the flow of the reagents along the reactor. At one side the cylindrical reaction vessel 3 was closed with a firm cover 22 with an input 14 of the reactor. On the other side it had an outlet connection terminal 24 closed with a valve 6 which was operated by means of a controlling system 23.

### Example 9

The electrode chemical reactor was similar to the one in the example five or seven but this time the cladding of the electrodes 1 and 2 was a substance with a structure of a polymer and the perpendicular reaction vessel 3 filled with the reagents 4 is situated at a high pressure tank.

### Example 10

The electrode chemical reactor was similar to the one in the example six but this time the cylindrical reaction vessel 3 filled with the reagents 4 was situated at a low pressure tank.

### Example 11

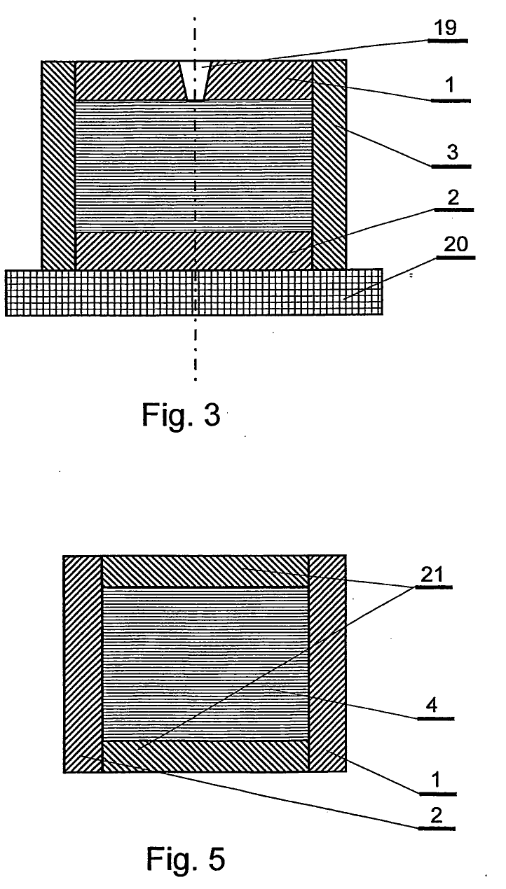

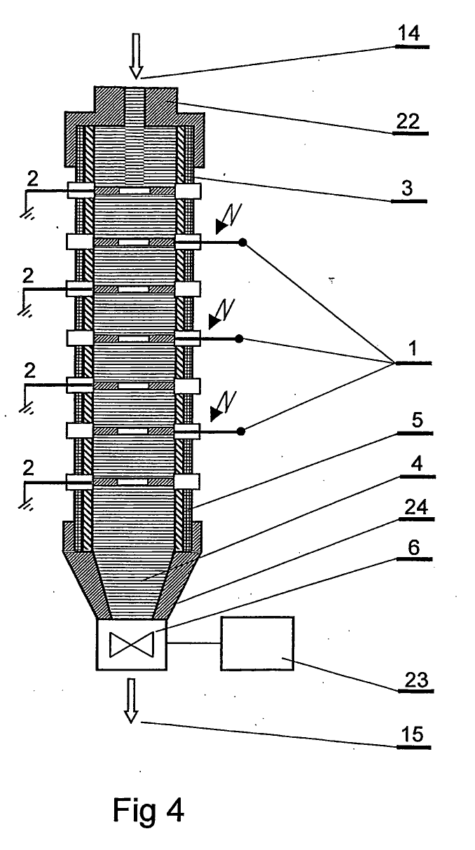

200 ml of 0.5M ZnCl2 solution of 99.995% purity was poured into a 500 ml beaker and treated with 0.5 M NaOH solution of 99.995% purity with a magnetic agitator raising a resulting suspension to ph value of 8 in relation to phenolphthalein. The received suspension was then placed inside the reactor (FIG. 3) and treated with a series of 15-ms electrical pulses of 20 kV voltage with frequency of 100/min for 10 minutes. Afterwards, the residue was separated from the mother liquid and rinsed with deionized water until there was no reaction to chloride ions (using standard laboratory techniques). Next it was subjected to triple rinsing with isopropanol. The rinsed residue was then dried in a laboratory dryer for 12 hours at a temperature of 90° C. The resulting substance is ZnO powder of 99.99% purity.

The electrodes of the chemical reactor may be in the form of flat plates, rods or tubes of any diameter. The operation of the reactor within neutral gases or the air in selected range of pressures, especially with elevated pressures, is realized by placing the reaction vessel in a low or high pressure tank which constitutes an external protective vessel. After that the electric terminals are connected to the external power supply adaptor by means of electric bushings integrated with the wall of the tank ensuring gas tightness.

The variation of the course of time featured by this generated voltage is not important. However, it is essential that the energy be supplied in big volumes over short periods of time. The voltage value, duration time of impulses as well as their frequency depends both on the substrates 11 and on the reaction product 8. Impulses in the rectangular form are especially recommended when taking into account their maximum energy. Nevertheless, when using electrodes with dielectric cladding the packs of sinusoidal impulses of high frequency or a series of short exponential impulses are also acceptable.

### LIST OF SYMBOLS

1—pulse electrode,
2—electrode,
3—reaction vessel,
4—reagent,
5—cladding—insulating coating,
6—valve,
7—product tank,
8—reaction products,
9—electric supply adaptor,
10—pump,
11—liquid substrate,
12—substrate tank,
13—connection terminal,
14—the input of the reactor,
15—the output of the reactor,
16—pulse electrode cooling system,
17—electrode cooling system,
17—water,
19—filler viewfinder,
20—dielectric base,
21—dielectric plate,
22—cover,
23—controlling system,
24—terminal

1. A method of chemical reactions conduction in which electrodes connected to a power supply are immersed in fluid reagents of which at least one component is capable of electric polarization, characterised in that the fluids reagents (4) are subjected to electric voltage in the form of short electric pulses generating unipolar or bipolar electric field pulses.

2. The method according to claim 1, characterized in that the minimum duration time of the electric pulses is from 50 ns and the maximum is 20 ms, while pause between the consecutive pulses is from 0.5 μs to 3 s.

3. The method according to claim 1, characterised in that the fluid reagents (4) are subjected to the electric voltage generating electric field strength with intensity of at least 100V/cm.

4. The method, according to claim 1, characterised in that the fluid reagents (4) are subjected to the pulses of electric voltage causing the delivery of the in-pulse electric power to be at least 10 times higher than the average power level.

5. The method, according to claim 1, characterised in that the fluid reagents (4) are cooled down.

6. The method according to claim 1, characterised in that the rate of tension increase in the pulse exceeds 108 V/sec.

7. The method according to claim 1, characterised in that time of the electric pulse duration, defined as time where 90% of the pulse energy is included, is in the range from 1 μs to 20 ms.

8. The method according to claim 1, characterised in that the power consumption in the reaction is more than 1 kW/ml.

9. The method according to claim 1, characterised in that the fluid reagents are under pressure up to 50 MPa.

10. A Chemical reactor with reaction vessel (3) for fluid reagents subjected to the reaction equipped with at least 2 electrodes (1, 2) to be immersed in the fluid reagents, where said electrodes are made of electrically conducting material and connected to electric power supply, characterised in that the electric power supply is a source of unipolar or bipolar pulses of pulsating DC or AC voltages which constitutes source of the electric field strength with amplitude exceeding 100V/cm while the electrodes (1,2) are in galvanic contact with the fluid reagents or are separated from by a relatively thin layer of dielectric material.

11. The chemical reactor according to claim 10, characterised in that the reaction vessel (3) has rectangular shape formed by two first parallel walls made of electrically conductive material and playing role of a pair of plate-type electrodes, as well as by second two parallel walls and bottom made of dielectrically isolating material.

12. The chemical reactor according to claim 10, characterized in that at least one electrode plays the role of one internal wall of the reaction vessel (3).

13. The chemical reactor according to claim 10, characterised in that the electrodes are connected by the bushings situated at the walls of the reaction vessel (3).

14. The chemical reactor according to claim 10, characterised in that the reaction vessel (3) filled with the fluid reagents (4) is situated in the high pressure tank.

15. The chemical reactor according to claim 10, characterised in that the reaction vessel (3) filled with the fluid reagents (4) is situated in the low pressure tank.

16. The chemical reactor according to claim 10, characterised in that the reaction vessel (3) filled with the fluid reagents (4) is fitted with the cooling system (16, 17).

17. The chemical reactor according to claim 10, characterised in that the electrodes (1, 2) immersed in the fluid reagents are connected to a cooling system (16, 17).

18. The chemical reactor according to claim 10, characterised in that the electrodes are made of a material not contaminating the reaction product.

19. The chemical reactor according to claim 10, characterised in that the electrodes are made of a material identical with the components of the reaction product.

20. The chemical reactor, according to claim 610, characterised in that a cladding made of low electric conduction material or of electric insulator are applied on the electrodes (1, 2).

21. The chemical reactor, according to claim 20, characterised in that the cladding is of porous texture.

22. The chemical reactor according to claim 6, characterised in that at least one electrode (1, 2) has form of a rectangular sheet metal.

23. The chemical reactor according to claim 10, characterised in that at least one electrode (1, 2) has form of a tube.

24. The chemical reactor according to claim 10, characterised in that at least one electrode (1, 2) has form of a rod.

25. The chemical reactor according to claim 10, characterised in that at least one electrode (1, 2) has form of a flat plate.

26. The chemical reactor according to claim 10, characterised by openings in at least one of the electrodes (1, 2).

27. The chemical reactor according to claim 10, characterised in that the rate of tension increase in the electric pulse exceeds 108 V/sec.

28. The chemical reactor according to claim 10, characterised in that the time of pulse duration, defined as time where 90% of the pulse energy is included, is in the range from 1 μs to 20 ms.

29. The chemical reactor according to claim 6, characterised in that the power consumption during the reaction is more than 1 kW/ml of the fluid reagents.

30. The chemical reactor according to claim 6, characterised in that the fluid reagents are under pressure up to 50 MPa.
